(19) United States
(12) Patent Application Publication
(10) Pub. No.: US 2017/0254429 A1
(43) Pub. Date: Sep. 7, 2017

(54) Automatic Shutoff Valve

(71) Applicants: Robert E. Hadd, Florence, OR (US); Howard Penn, Coloma, CA (US)

(72) Inventors: Robert E. Hadd, Florence, OR (US); Howard Penn, Coloma, CA (US)

(21) Appl. No.: 15/449,788

(22) Filed: Mar. 3, 2017

Related U.S. Application Data
(60) Provisional application No. 62/303,256, filed on Mar. 3, 2016.

(51) Int. Cl. F16K 21/18; E03D 1/30; F16K 31/32

(52) U.S. Cl. CPC F16K 21/18; F16K 31/32; E03D 1/304

(57) ABSTRACT

An automatic shutoff valve for water conservation consists of a stoppage valve, a central flow tube, a floatation device, and a clamping mechanism. The central flow tube is rotatably positioned within a shell body of the stoppage valve. The floatation device which determines the orientation of the central flow tube. To do so, the floatation device is mechanically engaged to the central flow tube. Depending on the orientation of the central flow tube, the stoppage valve obtains an open configuration or a closed configuration. When used within a toilet tank, the open configuration allows water to pass through the stoppage valve. In the closed configuration, the water flow through the stoppage valve is discontinued. A first pair of stoppers and a second pair of stoppers ensure that the stoppage valve transitions between the open configuration and the closed configuration in a small operational angle.

The current application claims a priority to the U.S. Provisional Patent application Ser. No. 62/303,256 filed on Mar. 3, 2016.

### FIELD OF THE INVENTION

The present invention relates generally to a float actuated valve, more particularly to a valve that uses the level of water in a toilet tank to govern the amount of water that flows into the toilet bowl. The present invention is a retrofit to a toilet with an overflow shutoff valve, which prevents water from being wasted by flowing over the weir of a toilet bowl.

### BACKGROUND OF THE INVENTION

In the daily life of an individual, a toilet is being used multiple times during the day. For each flush of the toilet, a significant amount of water is wasted. If the wasted water can be preserved, a considerable amount of water can be saved over an extended period. In existing toilet tanks, the toilet tank keeps filling via the refill tube even after the toilet bowl is filled to the bowl trap weir. More specifically, the refill tube continues to fill the toilet tank until the toilet tank is full. Thus, the excess water is wasted during a flush. Different methods have been used to reduce the amount of water that is filled to the toilet tank. Placing bricks, placing water-filled jugs within the toilet tank, and the use of low flow toilets are some of the well-known methods.

Displacing water within the toilet tank is one method that is used to save water per flush. As discussed, water-filled jugs or other comparable items are placed within the toilet tank with the intention of displacing water. Even though these methods work to some extent, the overall flush volume is reduced and leads to requiring multiple flushes. Thus, water is not saved as intended. Therefore, a method that does not reduce the flush volume and saves water during a flush is clearly required.

Not being a retrofit is another major issue with many water saving devices. As an example, most toilet tank systems need to be significantly modified in the process of installing a water saving device. The process of modifying an existing system and installing the water saving device can be stressful and time consuming. For user convenience, a device that can be installed on any existing toilet tank system is needed.

The objective of the present invention is to address the issues discussed above. In particular, the present invention introduces a retrofit device that can be installed in any existing toilet tank thereby eliminating the need to replace the toilet tank. By installing the present invention, approximately ½ a gallon is saved from each flush. Moreover, the present invention can be positioned per the toilet tank water flow. As an example, the positioning of the present invention can change from a high flow toilet tank to a low flow toilet tank. The present invention also prevents overflowing of the toilet bowl which usually occurs due to the excess water stored in the toilet tank.

### BRIEF DESCRIPTION OF THE DRAWINGS

FIG. 1A is a perspective view of the present invention being used in a toilet tank.

FIG. 1B is another perspective view of the present invention being used in a toilet tank.

FIG. 2 is a side view of the present invention being used in a toilet tank.

FIG. 3 is a top view of the present invention being used in a toilet tank.

FIG. 4A is a cross-sectional view of the central flow tube.

FIG. 4B is a cross-sectional view of the central flow tube being positioned within the shell body.

FIG. 5 is a cross-sectional view of the stoppage valve being in a closed configuration.

FIG. 6 is a cross-sectional view of the stoppage valve being an open configuration.

FIG. 7 is another cross-sectional view of the stoppage valve being in the closed configuration.

FIG. 8 is another cross-sectional view of the stoppage valve being in the open configuration.

### DETAIL DESCRIPTIONS OF THE INVENTION

All illustrations of the drawings are for the purpose of describing selected versions of the present invention and are not intended to limit the scope of the present invention.

The present invention introduces an automatic shutoff valve which actuates in a small operational angle. In particular, the preferred embodiment of the present invention is designed to actuate at a 13-degree angle compared to existing stoppage valves that turn on and turn off at a much larger 90-degree angle. The smaller operational angle increases efficiency and saves a significant amount of water when the present invention is used in a toilet. With reference to the preferred embodiment, the present invention helps save approximately half a gallon of water per flush with no change to the flush volume. In doing so, the present invention precisely controls the amount of water in the toilet bowl. The small degree of actuation allows the present invention to be used in other fields that require a valve with high efficiency. As an example, a different embodiment of the present invention can also be used as a gas shutoff valve. In such instances, a gas sensor will be operatively coupled with the present invention so that the present invention operates according to the environmental conditions.

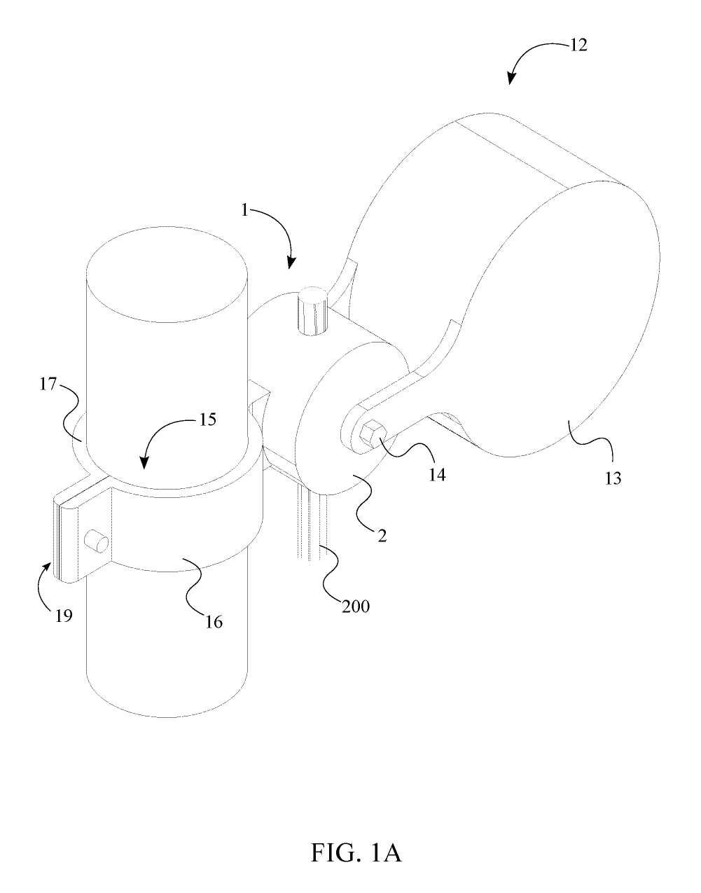

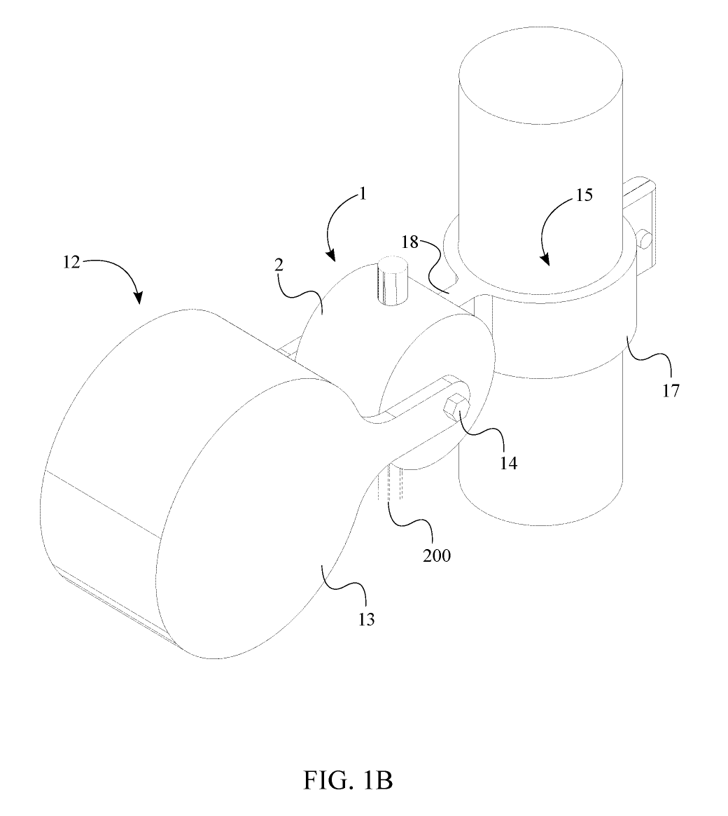

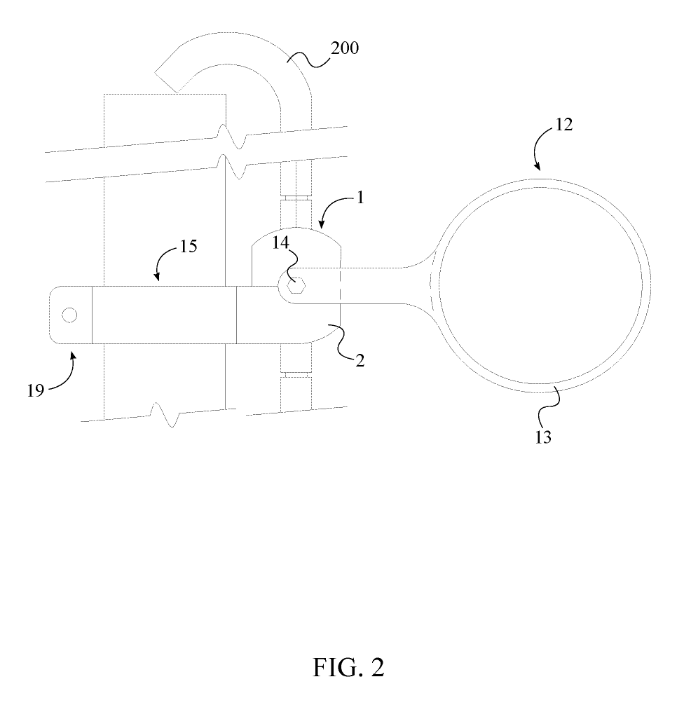

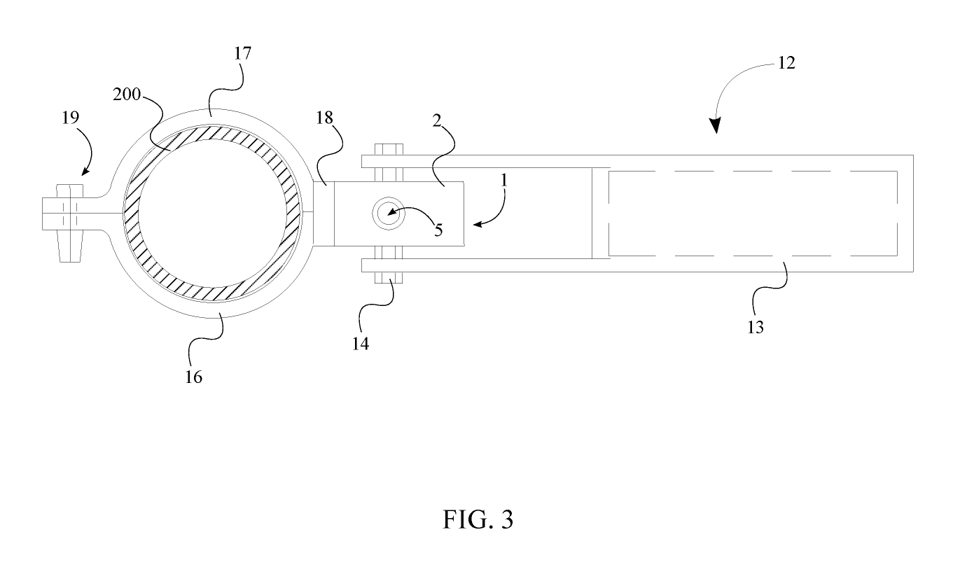

As illustrated in FIGS. 1-4A, the present invention comprises a stoppage valve 1, a central flow tube 6, a floatation device 12, and a clamping mechanism 15. The clamping mechanism 15 is used to position the present invention within the toilet tank. In the preferred embodiment, when the present invention is being used in a toilet, the clamping mechanism 15 is mounted onto the overflow tube of the toilet tank. The floatation device 12 is used to determine the presence of water within the toilet tank. More specifically, the floatation device 12 is used to determine when the water flow to the toilet tank needs to be continued or discontinued. Depending on the determination of the floatation device 12, the central flow tube 6 and the stoppage valve 1 operate to continue or discontinue the water flow into the toilet tank. A refill tube 200 is used to supply water to a toilet tank. Therefore, the central flow tube 6 and the stoppage valve 1 operate to either disrupt or allow the water flow within the refill tube 200.

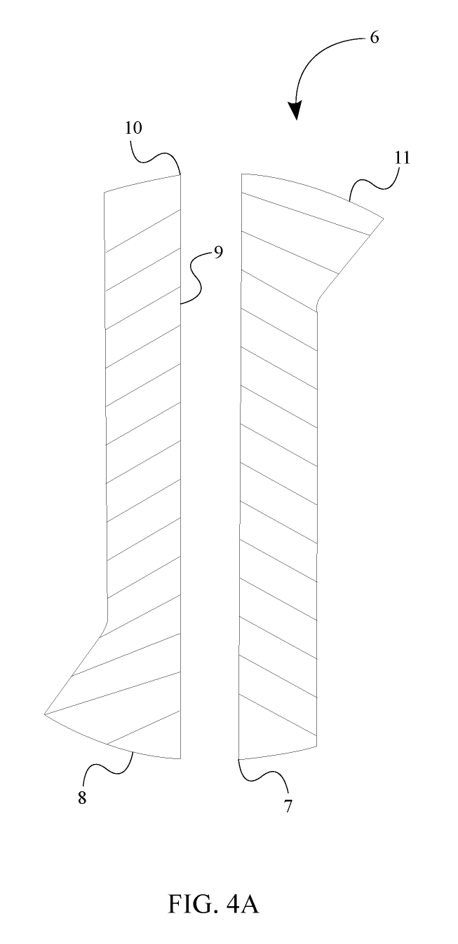

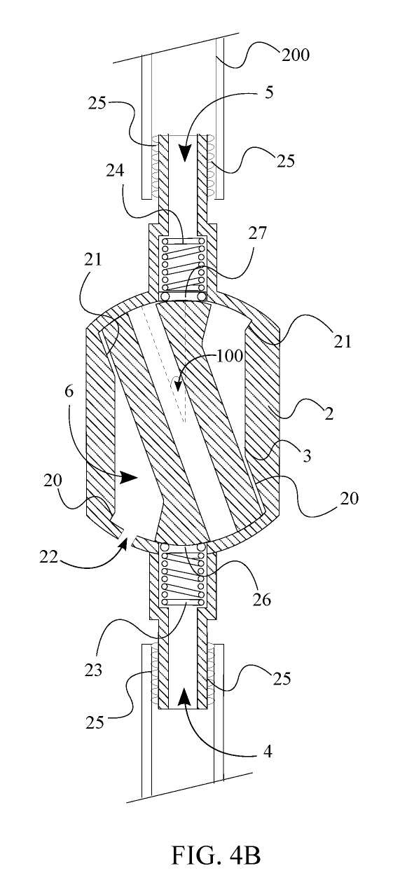

To be used for water flow control, the stoppage valve 1 comprises a shell body 2, an inlet spout 4, and an outlet spout 5 as illustrated in FIG. 4B. The central flow tube 6 is positioned within the shell body 2. The size and shape of the shell body 2 can vary in different embodiments of the present invention. The inlet spout 4 and the outlet spout 5 protrude outwards from the shell body 2. The inlet spout 4 and the outlet spout 5 are specifically designed to be inserted into the refill tube 200 so that the water flow through the refill tube 200 can be changed. Moreover, the inlet spout 4 and the outlet spout 5 are positioned opposite to each other across the shell body 2 so that the water flow travels through the shell body 2. For the inlet spout 4 and the outlet spout 5 to remain in position upon being inserted into the refill tube 200, the present invention further comprises a plurality of retention ridges 25. As seen in FIG. 4B, the plurality of retention ridges 25 is externally distributed along the inlet spout 4 and the outlet spout 5. Thus, the inlet spout 4 and the outlet spout 5 are pressed against the refill tube 200 and remains stationary when in use. The refill tube 200 usually has a tube diameter of ¼-inch. The inlet spout 4 and the outlet spout 5 are designed accordingly to fit inside the refill tube 200.

As seen in FIG. 4A and FIG. 4B, the central flow tube 6, which is pivotally mounted within the shell body 2, comprises a first end 7, a tube body 9, and a second end 10. The tube body 9 extends from the first end 7 to the second end 10 and provides a path for the water entering from the inlet spout 4 to exit through the outlet spout 5.

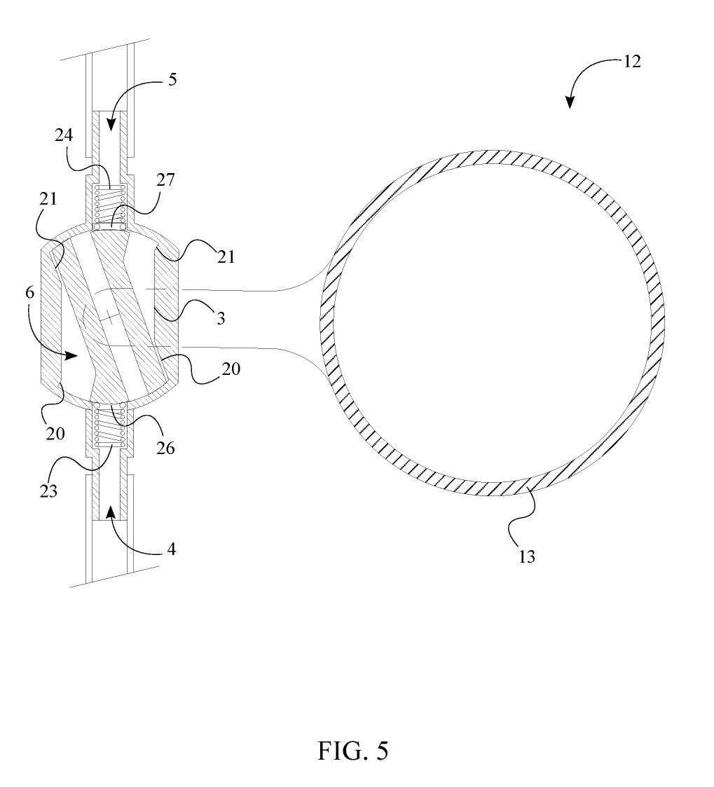

As discussed earlier, the water flow to the toilet tank relies on the determination of the floatation device 12. To utilize the floatation device 12 to control the water flow through the stoppage valve 1, the floatation device 12 is mechanically engaged to the central flow tube 6 as seen in FIGS. 5-8. The mechanical engagement allows the central flow tube 6 to adjust per the water level within the toilet tank. In doing so, the central flow tube 6 and the stoppage valve 1 continue or discontinue the water flow into the toilet tank.

The floatation device 12 orients the central flow tube 6 so that the stoppage valve 1 alternates between an open configuration and a closed configuration. To do so, the floatation device 12 comprises a floating member 13 and a shaft 14. The floating member 13 is connected to the shaft 14 which is used to orient the central flow tube 6. To do so, the shaft 14 is mechanically engaged with the central flow tube 6. Moreover, the floating member 13 and the central flow tube 6 is positioned opposite to each other along the shaft 14.

The present invention further comprises a first pair of stoppers 20 and a second pair of stoppers 21 that are used to control the movement of the central flow tube 6 within the shell body 2. An inner lateral wall 3 of the shell body 2 is used to appropriately position the first pair of stoppers 20 and the second pair of stoppers 21. More specifically, the first pair of stoppers 20 and the second pair of stoppers 21 are connected to the inner lateral wall 3. The central flow tube 6 is rotatably connected within the shell body 2, and in between the first pair of stoppers 20 and the second pair of stoppers 21. Therefore, the central flow tube 6 only rotates in a range determined by the first pair of stoppers 20 and the second pair of stoppers 21.

The first pair of stoppers 20, which is positioned adjacent the inlet spout 4, is used in controlling the water flow through the inlet spout 4. To do so, each of the first pair of stoppers 20 are positioned opposite to each other across the inlet spout 4. Therefore, the first end 7 of the central flow tube 6 can slide in between the each of the first pair of stoppers 20 and control the water flow as needed.

The second pair of stoppers 21, which is positioned adjacent the outlet spout 5, is used in controlling the water flow at the outlet spout 5. To do so, each of the second pair of stoppers 21 are positioned opposite to each other across the outlet spout 5. Therefore, the second end 10 of the central flow tube 6 can slide in between each of the second pair of stoppers 21 and control the water flow as needed.

To rotatably slide in between the first pair of stoppers 20 and the second pair of stoppers 21, and control the water flow at the inlet spout 4 and the outlet spout 5, the central flow tube 6 further comprises a first slide seal 8 and a second slide seal 11 as shown in FIG. 4A. The first slide seal 8 is terminally connected to the tube body 9 at the first end 7 and is used to control the water flow at the inlet spout 4. The second slide seal 11 is terminally connected to the tube body 9 at the second end 10 and is used to control the water flow at the outlet spout 5. The first slide seal 8 is positioned opposite the second slide seal 11 and diagonally across the tube body 9 so that the water flow through the central flow tube 6 is controlled within a small operational angle. As mentioned before, in the preferred embodiment of the present invention, the water flow changes at a 13-degree angle. However, the operational angle for the central flow tube 6 can vary in different embodiments of the present invention.

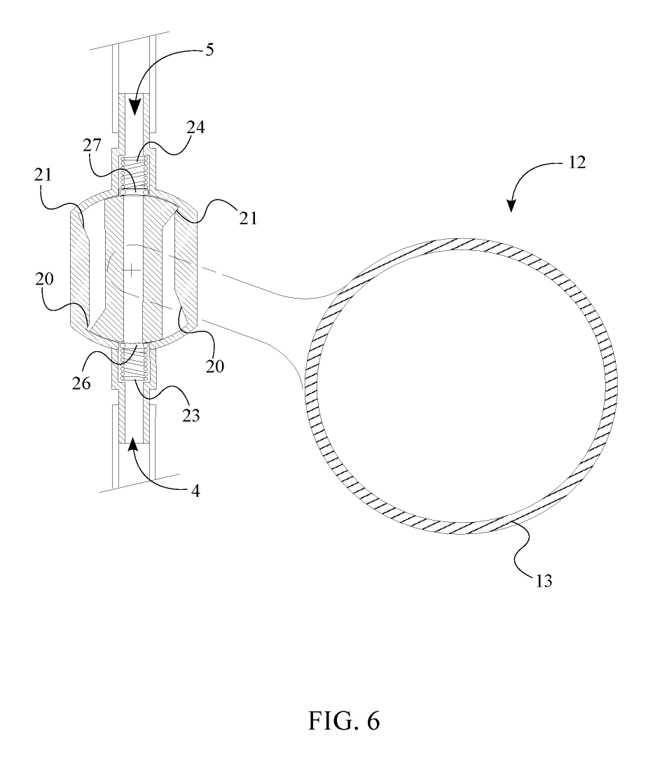

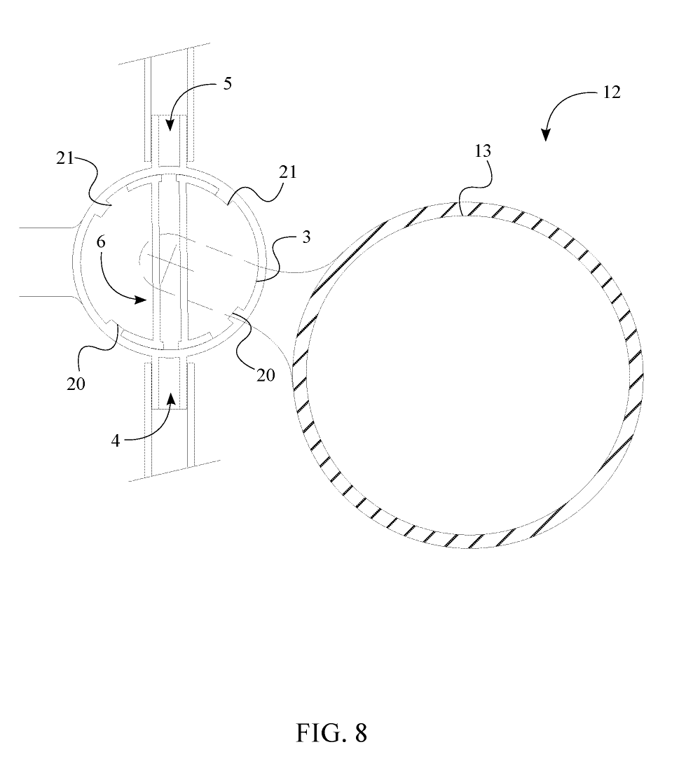

As mentioned earlier, the toilet tank is refilled via the refill tube 200. The stoppage valve 1 is connected to the refill tube 200 so that the water flow through the refill tube 200 can be controlled. Positioning of the refill tube 200 through the stoppage valve 1 is illustrated in FIG. 1A and FIG. 1B. For the water flow to continue through the refill tube 200, the stoppage valve 1 is in an open configuration as seen in FIG. 6 and FIG. 8. In the open configuration, the first end 7 is collinearly aligned with the inlet spout 4 allowing the water flow to continue into the tube body 9 via the inlet spout 4. Since the second end 10 is positioned opposite the first end 7 and across the tube body 9, the second end 10 is collinearly aligned with the outlet spout 5 simultaneously. Thus, water entering through the inlet spout 4, passes through the tube body 9, and exits the shell body 2 at the outlet spout 5. To do so, the inlet spout 4 is in fluid communication with the first end 7. Similarly, the outlet spout 5 is in fluid communication with the second end 10. The water continues to pass through the tube body 9 until the floatation device 12 orients the central flow tube 6 due to being lifted by the rising water level in the toilet tank. More specifically, the central flow tube 6 is oriented until the first slide seal 8 is in contact with one of the first pair of stoppers 20. Simultaneously, the second slide seal 11 will also be in contact with one of the second pair of stoppers 21. Thus, the stoppage valve 1 will be in a closed configuration.

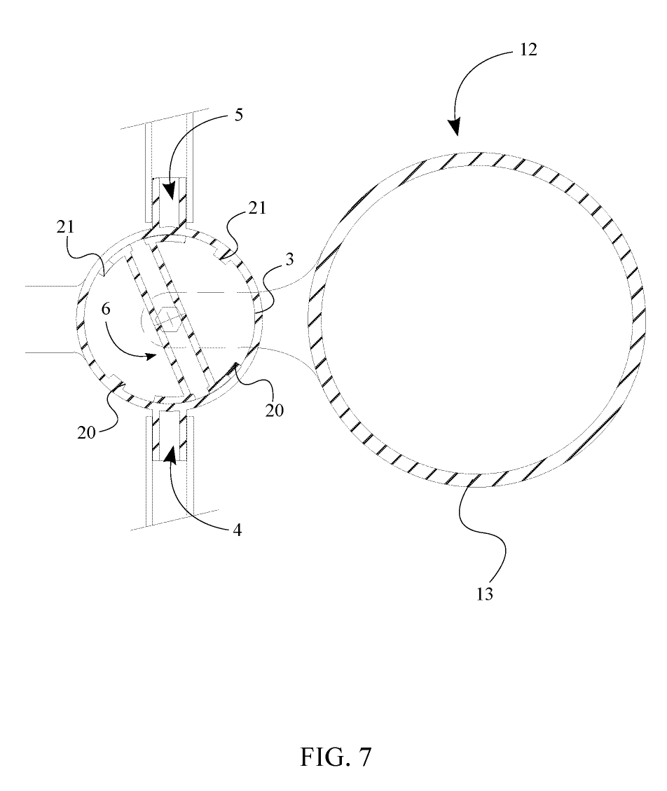

As seen in FIG. 5 and FIG. 7, in the closed configuration of the stoppage valve 1, the water flow through the inlet spout 4 is occluded by the first slide seal 8. Moreover, the water flow through the outlet spout 5 is occluded by the second slide seal 11. The resulting position of the central flow tube 6 prevents water from flowing to the toilet tank via the central flow tube 6. More specifically, in the closed configuration, the central flow tube 6 is positioned at a closing angle 100 from the inlet spout 4 and the outlet spout 5. The closing angle 100 for the preferred embodiment of the present invention is 13-degrees. However, the closing angle 100 can vary in other embodiments of the present invention. In the preferred embodiment of the present invention, the stoppage valve 1 is in the closed configuration when the toilet bowl is filled up to the toilet trap weir. The closed configuration prevents water from flowing into the toilet tank after the toilet bowl is filled up to the toilet trap weir.

The clamping mechanism 15, which is connected to the shell body 2, is used to position the present invention within the toilet tank. To do so, the clamping mechanism 15 comprises a first member 16, a fastening mechanism 19, a connecting arm 18, and a second member 17. The first member 16 is removably attached to the second member 17 with the fastening mechanism 19 so that the first member 16 and the second member 17 can be clasped around the overflow tube of the toilet tank. In order to do so, both the first member 16 and the second member 17 are C-shaped. When mounted as preferred, the connecting arm 18 connects the first member 16 and the second member 17 to the shell body 2. Preferably, the shell body 2 is positioned at a mechanically advantageous position along the refill tube 200. The exact positioning along the refill tube 200 can vary from one toilet tank to another depending on the water flow rate. The fastening mechanism 19 can vary in different embodiments of the present invention.

The present invention further comprises a weep hole 22 which traverses into the shell body 2. The weep hole 22 is used to drain any water from within the shell body 2 and is preferably positioned adjacent the inlet spout 4. Thus, the central flow tube 6 can rotate freely within the shell body 2.

The present invention further comprises an inlet pressure spring 23 and an inlet sealing washer 26. The inlet pressure spring 23 is positioned within the inlet spout 4 adjacent to the shell body 2. The inlet sealing washer 26 is terminally affixed to the inlet sealing washer 26 adjacent to the shell body 2. Both the inlet pressure spring 23 and the inlet sealing washer 26 are used to create a watertight seal between the central flow tube 6 and the inlet spout 4.

To create a watertight seal at the outlet spout 5, the present invention further comprises an outlet pressure spring 24 and an outlet sealing washer 27. In this instance, the outlet pressure spring 24 is positioned within the outlet spout 5 adjacent to the shell body 2. On the other hand, the outlet sealing washer 27 is terminally affixed to the outlet pressure spring 24 adjacent to the shell body 2.

When the present invention is being used, the following process flow is generally followed. The present invention is positioned as required with the clamping mechanism 15. However, the attachment point and the clamping mechanism 15 can vary in different embodiments of the present invention. In the preferred embodiment, the clamping mechanism 15 is mounted onto the overflow tube in a toilet tank. Upon being mounted onto the overflow tube, the shell body 2 is connected to the refill tube 200. The connection point can vary from one toilet tank to another. As an example, if the toilet tank is a high flow toilet, the shell body 2 is positioned close to the fill valve on the refill tube 200. On the other hand, if the toilet tank is a low flow toilet, the shell body 2 is connected away from the fill valve on the refill tube 200. When connecting the shell body 2 to the refill tube 200, the inlet spout 4 is inserted into one open end of the refill tube 200. The outlet spout 5 is inserted into the other open end of the refill tube 200. The connection between the shell body 2 and the refill tube 200 establishes a path for the water to flow through to the toilet tank. When the shell body 2 is appropriately positioned, the floatation device 12 is positioned as necessary to determine the amount of water within the toilet tank.

When the floatation member 13 drops beyond a predetermined point, the central flow tube 6 collinearly aligns with the inlet spout 4 and the outlet spout 5. Thus, the water flow is continued through to the toilet tank. When the water fills up to the toilet trap weir, the floating member 13 rises so that the shaft 14 orients the central flow tube 6. The new orientation of the central flow tube 6 results in the closed configuration of the stoppage valve 1. Thus, the water flow to the toilet tank is discontinued. The effective design of the present invention precisely interrupts and controls the flow of water from the fill valve to the overflow tube. Thus, the present invention controls the water flow to the toilet bowl.

Although the invention has been explained in relation to its preferred embodiment, it is to be understood that many other possible modifications and variations can be made without departing from the spirit and scope of the invention as hereinafter claimed.

What is claimed is:

1. An automatic shutoff valve comprises:
a stoppage valve;
a central flow tube;
a floatation device;
a clamping mechanism;
the stoppage valve comprises a shell body, an inlet spout, and an outlet spout;
the central flow tube comprises a first end, a tube body, and a second end;
the tube body extending from the first end to the second end;
the central flow tube being pivotally mounted within the shell body;
the inlet spout and the outlet spout protruding outwards from the shell body;
the inlet spout and the outlet spout being positioned opposite to each other across the shell body;
the floatation device being mechanically engaged to the central flow tube; and
the clamping mechanism being connected to the shell body.

2. The automatic shutoff valve as claimed in claim 1 comprises:
a first pair of stoppers;
a second pair of stoppers;
the shell body comprises an inner lateral wall;
the first pair of stoppers and the second pair of stoppers being connected to the inner lateral wall;
the central flow tube being rotatably connected within the shell body;
the first pair of stoppers being positioned adjacent the inlet spout;
each of the first pair of stoppers being positioned opposite to each other across the inlet spout;
the second pair of stoppers being positioned adjacent the outlet spout; and
each of the second pair of stoppers being positioned opposite to each other across the outlet spout.

3. The automatic shutoff valve as claimed in claim 1 comprises:
the central flow tube further comprises a first slide seal and a second slide seal;
the first slide seal being terminally connected to the tube body at the first end;
the second slide seal being terminally connected to the tube body at the second end; and
the first slide seal being positioned opposite the second seal diagonally across the tube body.

4. The automatic shutoff valve as claimed in claim 3 comprises:
wherein the stoppage valve is in an open configuration;
the first end being collinearly aligned with the inlet spout;
the second end being collinearly aligned with the outlet spout;
the inlet spout being in fluid communication with the first end; and
the outlet spout being in fluid communication with the second end.

5. The automatic shutoff valve as claimed in claim 3 comprises:
wherein the stoppage valve is in a closed configuration;
a closing angle;
the inlet spout being occluded by the first slide seal;
the outlet spout being occluded by the second slide seal; and
the central flow tube being positioned at the closing angle from the inlet spout and the outlet spout.

6. The automatic shutoff valve as claimed in claim 5, wherein the closing angle is 13-degrees.

7. The automatic shutoff valve as claimed in claim 1 comprises:
the floatation device comprises a floating member and a shaft;
the floating member being connected to the shaft;
the shaft being mechanically engaged with the central flow tube; and
the floating member and the central flow tube being positioned opposite to each other along the shaft.

8. The automatic shutoff valve as claimed in claim 1 comprises:
the clamping mechanism comprises a first member, a fastening mechanism, a connecting arm, and a second member;
the first member being removably attached to the second member with the fastening mechanism; and
the first member and the second member being connected to the stoppage valve via the connecting arm.

9. The automatic shutoff valve as claimed in claim 8, wherein the first member and the second member are C-shaped.

10. The automatic shutoff valve as claimed in claim 1 comprises:
a weep hole; and
the weep hope traversing into the shell body.

11. The automatic shutoff valve as claimed in claim 1 comprises:
an inlet pressure spring;
an inlet sealing washer;
the inlet pressure spring being positioned within the inlet spout adjacent to the shell body; and
the inlet sealing washer being terminally affixed to the inlet pressure spring.

12. The automatic shutoff valve as claimed in claim 1 comprises:
an outlet pressure spring;
an outlet sealing washer;
the outlet pressure spring being positioned within the outlet spout adjacent to the shell body; and
the outlet sealing washer being terminally affixed to the outlet pressure spring.

13. The automatic shutoff valve as claimed in claim 1 comprises:
a plurality of retention ridges; and
the plurality of retention ridges being externally distributed along the inlet spout and the outlet spout.
